(19) United States
(12) Patent Application Publication
(10) Pub. No.: US 2019/0278949 A1
(43) Pub. Date: Sep. 12, 2019

(54) HARD SWITCH SECURE COMMUNICATION DEVICE

(71) Applicant: MAGIC MOBILE COMMUNICATIONS HOLDINGS, LLC, Westbury, NY (US)

(72) Inventors: James M. Wu, Great Neck, NY (US); John McAfee, Westbury, NY (US); Joseph DiRenzo, Westbury, NY (US); Victor Wang, Westbury, NY (US); Dee Jae Diliberto, Westbury, NY (US)

(21) Appl. No.: 16/295,924

(22) Filed: Mar. 7, 2019

Related U.S. Application Data
(60) Provisional application No. 62/639,828, filed on Mar. 7, 2018.
(60) Provisional application No. 62/639,830, filed on Mar. 7, 2018.
(60) Provisional application No. 62/639,833, filed on Mar. 7, 2018.

(51) Int. Cl. G06F 21/74; H04L 29/06; H04B 1/16; H04M 1/725; G06F 21/84; G06F 21/83

(52) U.S. Cl. CPC G06F 21/74; H04L 63/16; G06F 21/83; H04M 1/72577; G06F 21/84; H04B 1/1615

(57) ABSTRACT

A cellular communication device uses manually operated airgap switches that selectively enable or disable various functions of the communication device. The airgap switches physically disconnect conductors associated with power or signal transmission so that the operator is assured that the disabled function is not vulnerable to software-based intrusions. The various functions may include GPS, NFC, Bluetooth, WiFi, and cellular wireless devices. The functions may also include transducers such as a camera or microphone. In other cases, the disabled functions may include sensors such as an accelerometer, gyroscope, or compass that may be used to create a dead-reckoning trail.

### CLAIM OF PRIORITY

This application claims priority to U.S. Provisional Application 62/639,828 filed Mar. 7, 2018, U.S. Provisional Application 62/639,830 filed Mar. 7, 2018, and U.S. Provisional Application 62/639,833 filed Mar. 7, 2018, the entire contents of which are incorporated by reference for all purposes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Communication devices, particularly smartphones offer many conveniences from making calls, staying connected on social media, and getting location-based information. At the same time, it is becoming increasing difficult to ensure that unauthorized parties also do not have access to the features and functions of the smartphone in a breach of personal privacy.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A personal communication device may include one or more hard switches, also called airgap switches, to control various functions on the device. These switches ensure that a user can disable certain functions such as location, camera, and voice communication even if the device's software has been compromised. In this way, the device's user can be assured that the device is not surreptitiously monitoring location, surroundings, or conversations.

### BRIEF DESCRIPTION OF THE DRAWINGS

FIG. 1 is a block diagram illustrating the operating environment for the communication device in accordance with the current disclosure;

FIG. 2 is a block diagram illustrating an embodiment of a communication device of FIG. 1 in accordance with the current disclosure;

FIG. 3 is a block diagram illustrating another embodiment of the communication device of FIG. 1 in accordance with the current disclosure;

FIG. 4 is a block diagram illustrating yet another embodiment of the communication device of FIG. 1 tailored for location tracking protection;

FIG. 5 is a block diagram illustrating an embodiment of the communication device of FIG. 1 tailored for eavesdropping protection;

FIG. 6 is a diagram illustrating an airgap switch in accordance with the current disclosure;

FIG. 7 is a diagram illustrating an airgap antenna switch;

FIG. 8 is an illustration of switch grouping;

FIG. 9 is an illustration of an alternate embodiment of switch grouping;

FIG. 10 is a schematic diagram illustrating switch coding;

FIG. 11 is a schematic diagram illustrating switch enabling; and

FIG. 12 is a flowchart of a method of operating a communication device in accordance with the current disclosure.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

A personal communication device with manually operated security features may include hard-switched features including various radio frequency (RF) devices such as GPS, voice communication, data communication, and near field communication, as well as camera, and microphones/speakers.

Communication devices such as smartphones and tablets have become ubiquitous in our society. They are used for everything from a simple phone call to social media contacts to banking. The devices provide conveniences not contemplated even 15 years ago. These devices also have some drawbacks not fully comprehended as the technology developed. Among these may be ubiquitous location tracking without the knowledge or consent of the operator, identity theft or loss of personal data due to compromised software, and/or eavesdropping through a device's microphone and camera. In some cases such surveillance may occur even when the device appears to be shut down or in a limited communication state such as “airplane mode.”

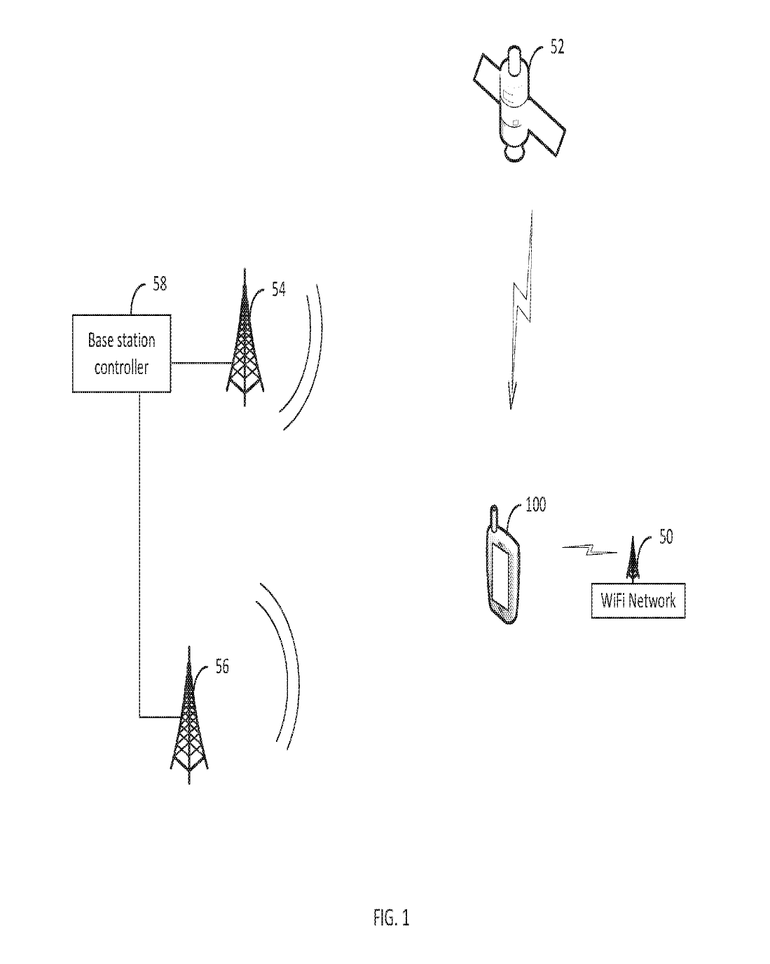

FIG. 1 is a block diagram illustrating an exemplary operating environment for a communication device 100 in accordance with the current disclosure. The communication device 100 may be a smartphone, a tablet, a personal digital assistant, or other electronic device capable of communication with an outside entity via a communication channel, for example, a cellular network or WiFi (IEEE 802.11) connection. The communication device 100 may also include one or more location services such as a GPS system and/or a dead reckoning system using a one or more of a compass, accelerometer, gyroscope, etc.

The communication device 100 may be in communication with a Wireless Fidelity (WiFi) network, for example, a short range network defined under the IEEE 802.11 family of specifications. Other short range networks may include Bluetooth, Bluetooth Low Energy (BLE), and other near-field communication (NFC). The communication device 100 may also be in communication with one or more cellular telephone towers 54, 56. The communication device 100 may receive a signal from one or more of the constellation of global positioning satellites 52 used to develop accurate location data at the communication device 100. A base station controller 58 may capture signals from the communication device 100 via one or both of the cellular telephone towers 54, 56.

As may be apparent, any of these communication mechanisms may be used separately or in combination to track the location of the communication device 100, either in real time or after gaining access to the communication device 100 itself. For example, the base station controller 58 may track movement of the communication device 100 through the coverage areas of an individual tower 56 or may develop location information based on signal strength of the communication device 100 at two or more base station devices.

WiFi networks 50 may be linked to form a grid of hotspots (not depicted) that can use registration data to track a communication device 100 without a user of the communication device 100 even connecting to any of the networks in the grid. Similarly, Bluetooth access points in stores and Internet of Things devices such as appliances can track a communication device 100 without the user's knowledge or permission.

GPS data may be relayed to an external device via cellular or short range data connections if one or more applications (apps) on the communication device 100 openly or surreptitiously collect such information. Even absent an offending app, the GPS data may be stored as a function of the device operating system and may be available to anyone with access to the communication device 100 even for a short period of time. As discussed more below, other sensors and transducers may be used to infer location via dead-reckoning, image matching, background sounds, etc.

Beyond the compromise of location, the sensors and transducers may be coopted to record and/or transmit audio and video from the communication device 100 even when these devices are presumed to be off or an associated activation light (e.g. for a camera) is not illuminated. The compromise of personal information described above may, at least in part be due to the use of software to control each of the above-described functions and internal systems, including indicator lights.

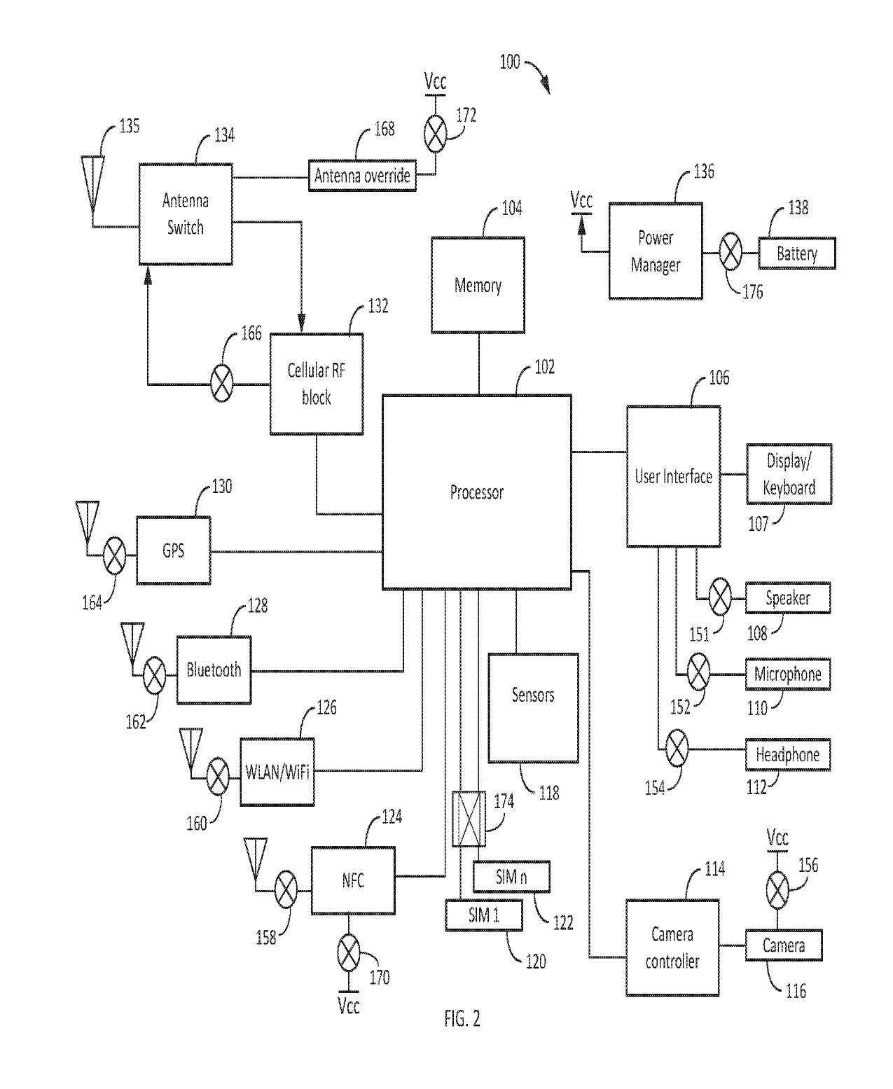

Turning to FIG. 2, a block diagram of the communication device 100 is used to illustrate a number of mechanisms for physically controlling the communication device's hardware components to reduce or eliminate completely surreptitious use. The communication device 100 is designed on the premise that software operating system and applications installed on the device 100 may inevitably be compromised. The communication device 100 uses airgap switches to enable and disable certain features of the communication device 100 so that even should the system software or applications “go rogue” the device's user can ensure various features and functions are not operable.

In the illustrated embodiment, the communication device 100 may include one or more processors 102 and a memory 104 used to store executable instructions and data. A user interface controller 106 may be coupled to a display/keyboard 107 that may be or include a display and touchscreen as well as physical switches for power, volume, etc., in a conventional manner. The user interface controller 106 may also support a speaker 108, a microphone 110, and a headphone jack 112. In some embodiments, more than one speaker or microphone may be present. A camera controller 114 may be coupled between a camera 116 and the processor 102. In an embodiment, the camera controller 114 may process images, for example, to correct for lens aberrations or to generate a high dynamic resolution (HDR) image from multiple exposures.

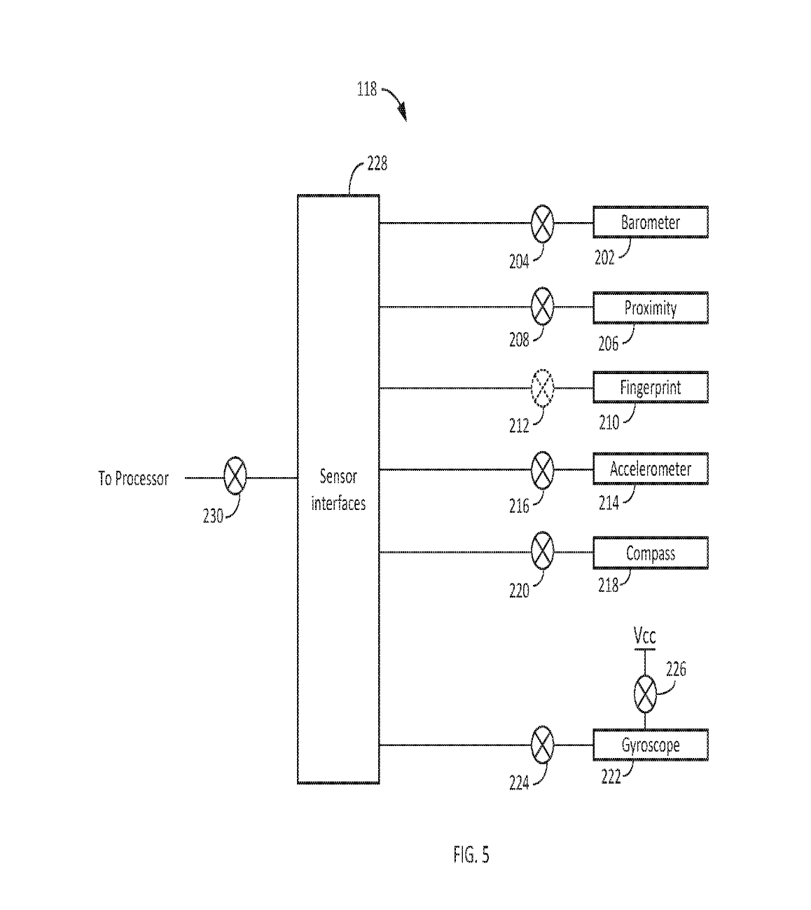

A number of sensors 118 may be used to provide environment information to the communication device 100, such as an accelerometer, compass, gyroscope and more. The sensors 118 are discussed more below with respect to FIG. 5.

A subscriber identity module (SIM) 120 may be used in some communication devices to support communications with a service provider or carrier. The SIM 120 may include subscriber data, stored information such as contacts, and cryptographic secrets used, among other things, to validate communication sessions. An alternate SIM 122 may be used to provide a second identity to the communication device 100 as described more below.

Signaling devices, described below may be used to receive and/or send signals with external devices. The signaling devices may include a near field communication (NFC) device 124 such as Bluetooth Low Energy (BLE). NFC communications may be used for very short range communications, such as using the communication device 100 for payments at a point of sale device. A WiFi device 126 may be used for local area communications via any of a number of IEEE 802.11 standards. A Bluetooth device 128 may communicate over shorter ranges and may be primarily used for communication with accessories such as wireless speakers and headphones.

A GPS receiver 130 uses signals from a number of satellites in the GPS satellite constellation to generate a location of the communication device 100. While the GPS receiver 130 is not capable of sharing that location information, as discussed above, the location information may be stored, used, and/or transmitted by one of the other two-way communication devices.

Lastly, the cellular RF block 132 may include one or more subsystems for communication over various cellular networks including GSM and CDMA. The cellular RF block may have separate transmit and receive ports for separating the higher power transmitter portion from the more sensitive receiver portion. An antenna switch 134 may be used to selectively connect either the transmitter or the receiver to the antenna 135 so that transmit energy is not fed directly into the receiver. In some embodiments a circulator may be used instead of the antenna switch 134. The antenna switch 134 is discussed more below with respect to FIG. 7. A power manager 136 may be used to selectively provide power to components of the communication device 100 in order to preserve the life of the battery. The output of the power manager is referred to as Vcc. The term Vcc is synonymous with battery voltage or power, and is introduced here for the purpose of later discussions.

As mentioned above, there are numerous vulnerabilities to personal privacy associated with almost all of the components of the communication device 100. A communication device 100 in accordance with the current disclosure may be configured so that a user of the communication device 100 is able to limit, if not eliminate, most of those vulnerabilities, at least for a time.

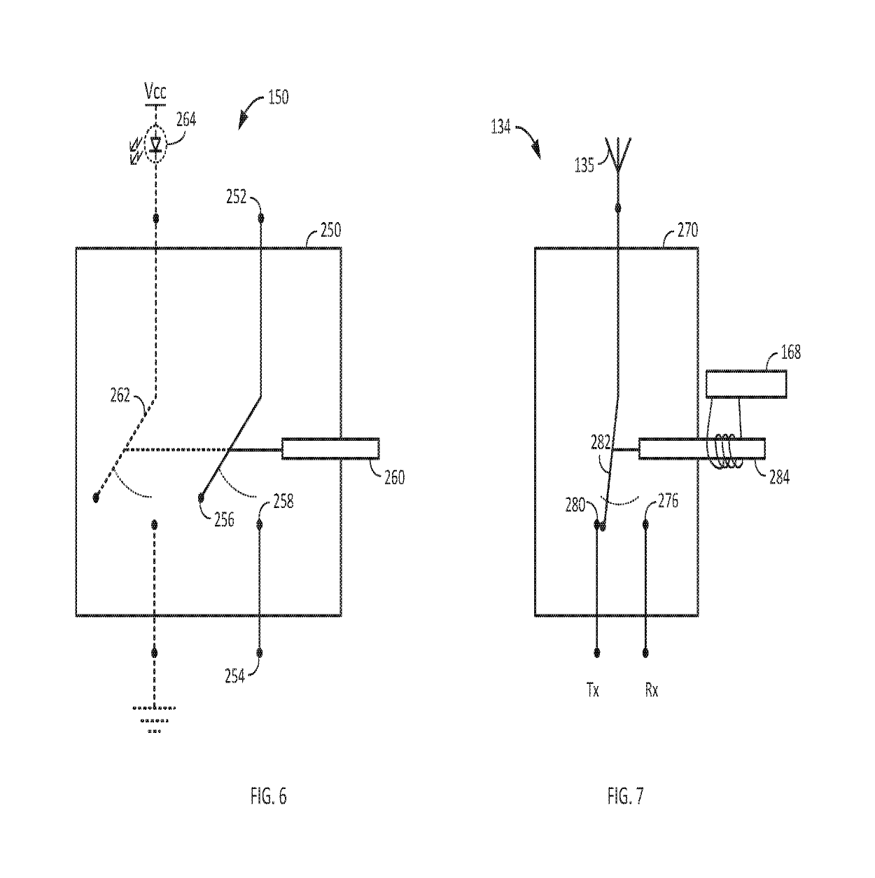

Turning briefly to FIG. 6, an airgap switch 150 is illustrated. The airgap switch 150 may include a housing 250, and input and output terminals 252 and 254. An armature 256 may selectively be connected to a contact 258 via movement of a lever 260, knob, button or the like. The lever 260 may be manually operated, that is, by physical movement caused by a user of the communication device 100. In an embodiment, the lever action is stable so that one activation of the lever 260 opens the circuit and another activation of the lever 260 closes the circuit, similar to a simple light switch. In another embodiment, the lever 260 may be a momentary switch that either closes or opens the circuit only with the lever 260 is held in place.

While the illustrated embodiment uses mechanical switches for electrical circuits, an alternate embodiment may include optical switches for use in switching optical signals. The optical switch may be a microelectromechanical system (MEMS) switch such as are commercially available from commercial sellers such as DiCon Fiberoptics, Inc. and Agiltron Inc.

One embodiment of the airgap switch 150 may also include an indicator light 264 that operates in concert with the armature 256. As shown in this illustration, the light 264 will activate when the armature 256 closes the circuit. In another embodiment, the light 264 may illuminate when the circuit is open. This may be accomplished either mechanically or electrically, for example using an inverter. The variations of light operation will be apparent to one of ordinary skill in electric circuitry.

A number of airgap switches are discussed below, it should be understood that each of the following airgap switches may be the same or similar to one of the embodiments of the airgap switch 150 discussed above.

Returning to FIG. 2, the airgap switch 151 may be used to manually disconnect the speaker 108 from the user interface circuit 106. In some cases, the transducer in a speaker may be monitored in order to pick up audio content like a microphone. In order to prevent such an occurrence, the airgap switch 151 may be inserted in the signal line to the speaker 108 to physically disconnect the signal path and prevent a signal from traveling in either direction.

In similar fashion to the speaker 108, an airgap switch 152 may be used to disable the microphone 110, while an airgap switch 154 may be used to disconnect the headphone jack 112. In one embodiment, a multiple pole-single throw switch (not depicted) could be used to disable all three of the audio-oriented transducers (108, 110, 112) at the same time.

In a variation on the signal path disruption of, for example, the airgap switch 110 for the microphone, an airgap switch 156 may be used to disable the camera 116 by disconnecting the power (Vcc) to the camera 116. Of course, a connection between the camera 116 and camera controller 114 or between the camera controller 114 and the processor 102 may be switched but in the case where the connection is via a databus with many individual conductors, controlling the power may be more efficient.

The NFC device 124 is illustrated as having an airgap switch 158 to disconnect its antenna but is also shown as having an airgap switch 170 to control power to the NFC device 124. In an embodiment, the antenna switch 158 for the NFC device 124 may be a momentary switch so that the antenna is only connected while the switch is physically held closed. In some cases, powering off a device, such as the NFC device 124 may allow for a fast startup and recovery when power is reapplied. However, in other cases, such as a GPS receiver 130 or a WiFi device 126, the startup time may be time consuming as ephemeris data is reapplied or discovery and connection handshaking are processed. So, while switch power is an option for most of the devices in the communication device 100, it may be more efficient for some to simply have an antenna disconnected to disable and reconnected to enable a current session. As such, the WiFi device 126, the Bluetooth device 128, and the GPS receiver 130 may have corresponding airgap switches 160, 162, 164 that disconnect the device from its respective antenna.

However, putting a generic airgap switch in line with an RF path may not be conducive to optimum RF performance because of the effects of path length and the complex impedances that can result from the armature 256 to contact 258 connection. With this in mind, the antenna switch 134 may be a specialized switch that is design for compatibility with very high frequency, broadband RF systems. In this case, it may be advantageous to use an airgap switch 172, not in the signal path to an antenna 135, but to control the position of the antenna switch 134.

Turning briefly to FIG. 7, an exemplary antenna switch is illustrated with a housing 270 and showing that the antenna 135 may be connected by an armature 282 to either the transmit (Tx) side of the cellular RF block 132 via the contact 280 or to the receive (Rx) side of the cellular block via the contact 276. In one embodiment, the position of the armature 282 may be controlled by a solenoid 284 that may be operated by system software or may be manually overridden by an antenna override circuit 168.

Returning to FIG. 2, it can be seen that the antenna override circuit 168 may be under the control of the manually operated airgap switch 172. For example, providing power to the antenna override circuit 168 may cause power to be applied to the solenoid 284 and keep the armature 282 in the Rx position as long as the airgap switch 172 is closed. When the cellular RF block 132 is not able to transmit because its transmitter cannot be connected to the antenna 135, the communication device 100 may be effectively disabled from transmitting information such as GPS location. It may be noted that when the communication device 100 cannot respond to polling messages such as signal strength requests from the base station controller 58, the communication device 100 may, at some point also not be able to receive any messages even though the receiver portion of the cellular RF block 132 may be enabled and coupled to the antenna 135.

The SIM 120 may normally be connected to the processor 102 for normal activity. It may be desirable at some point for the identity associated with the SIM 120 to go “dark” and not be accessible or trackable when the communication device 100 is in an full operating mode. In this case, one or more airgap switches 174 may allow connection of the second SIM 122 to become active and take the subscriber identification number associated with the second SIM 122. In other embodiments, the ability to switch between SIM cards may simply accommodate better rates or data plans available in different regions and/or on different carriers.

In yet another embodiment, an airgap switch 176 may be placed at an output of the battery 138. By cutting off power to the communication device 100, all functions of the communication device 100 may be activated, given several seconds or minutes for internal power filters to discharge. Only if the communication device 100 is equipped with an RF identifier device (RFID) (not depicted) would there be some risk of the communication device 100 being identified because an RFID does not always rely on internal power to transmit its identification data.

The use of the airgap switches throughout the communication device 100 gives the user a highly flexible platform for secure operation, for example, by turning off all radio frequency communications or by turning off any transducers capable of eavesdropping on an environment via audio or video.

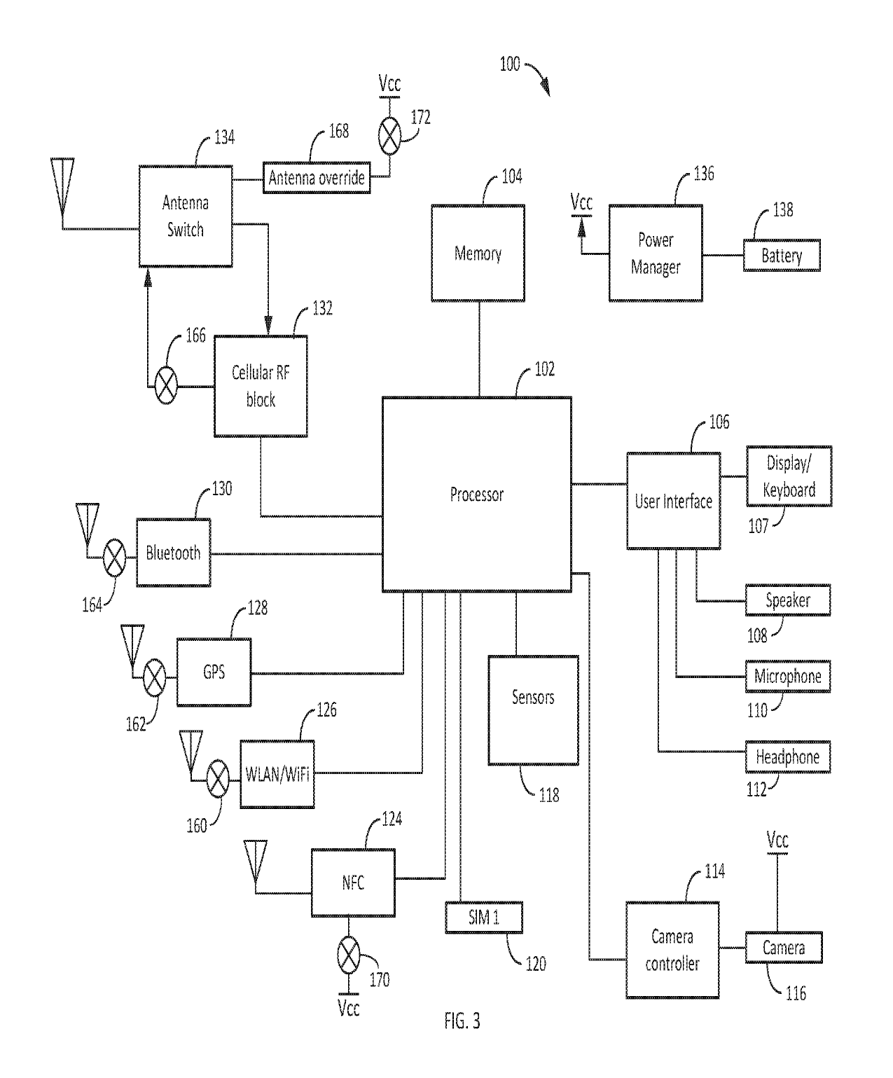

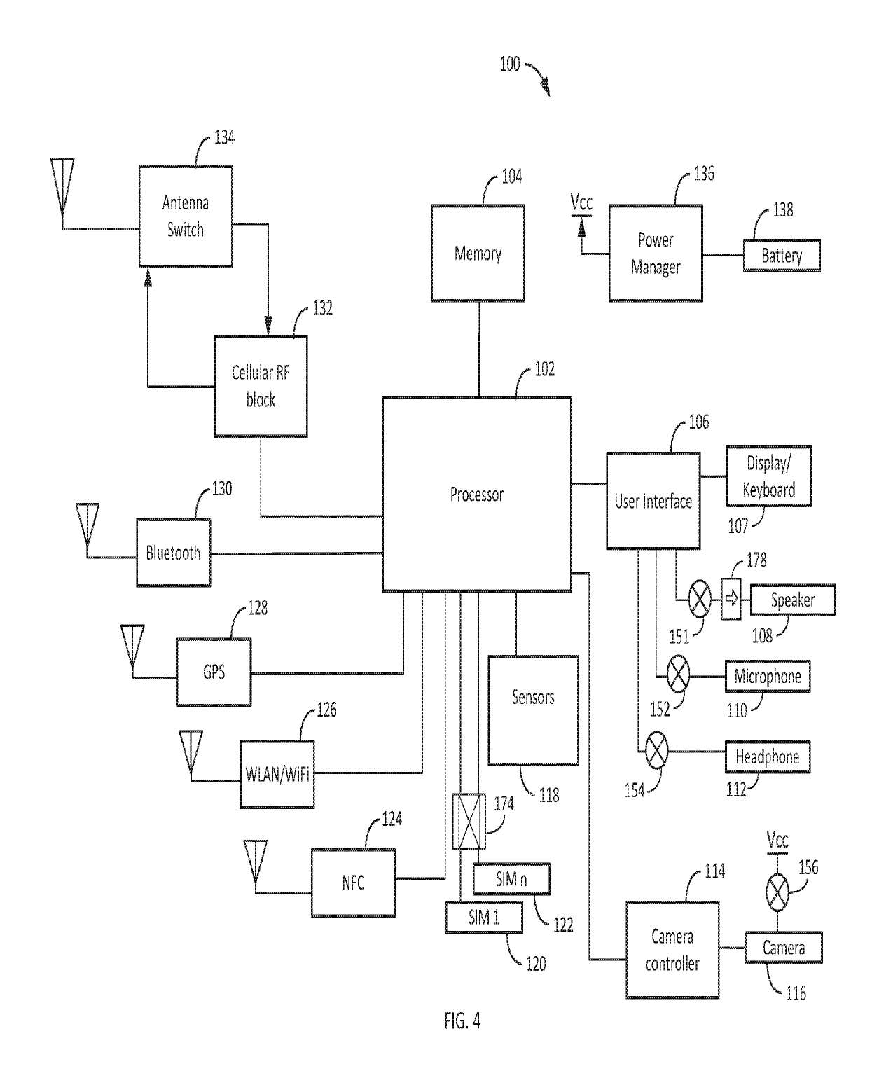

In some cases, the communication device 100 may be configured for addressing one or another of the various threats separately. FIGS. 3 and 4 illustrate two such configurations. FIG. 3 is a block diagram illustrating a tracking-resistant configuration having airgap switches available for the RF devices including the NFC device 124 and an associated power control airgap switch 170, the WiFi device 126 and antenna airgap switch 160, the GPS receiver and antenna airgap switch 162, and the Bluetooth receiver 130 and its antenna airgap switch 164. As discussed above, any of these RF components may be manually enabled or disabled via antenna switches, power switches, or both. As discussed above with respect to FIG. 2, the cellular RF block 132 may be enabled or disabled via the manual antenna switch override circuit 168 and its associated airgap switch 172.

While the configuration of FIG. 3 may be directed to tracking resistance, the configuration of FIG. 4 may be directed to eavesdropping resistance. In this embodiment, transducers for audio and video may be disabled via airgap switches 151, 152, 154 and 156. Also illustrated in FIG. 4 is an optical coupler 178 that may be inserted to prevent electrical signals induced by sound picked up at the speaker from being transmitted back to the user interface 106 and ultimately, the processor 102. In this configuration, the alternate SIM airgap switch 174 may be used to hide one or the other of the identities represented by SIM 120 and SIM 122.

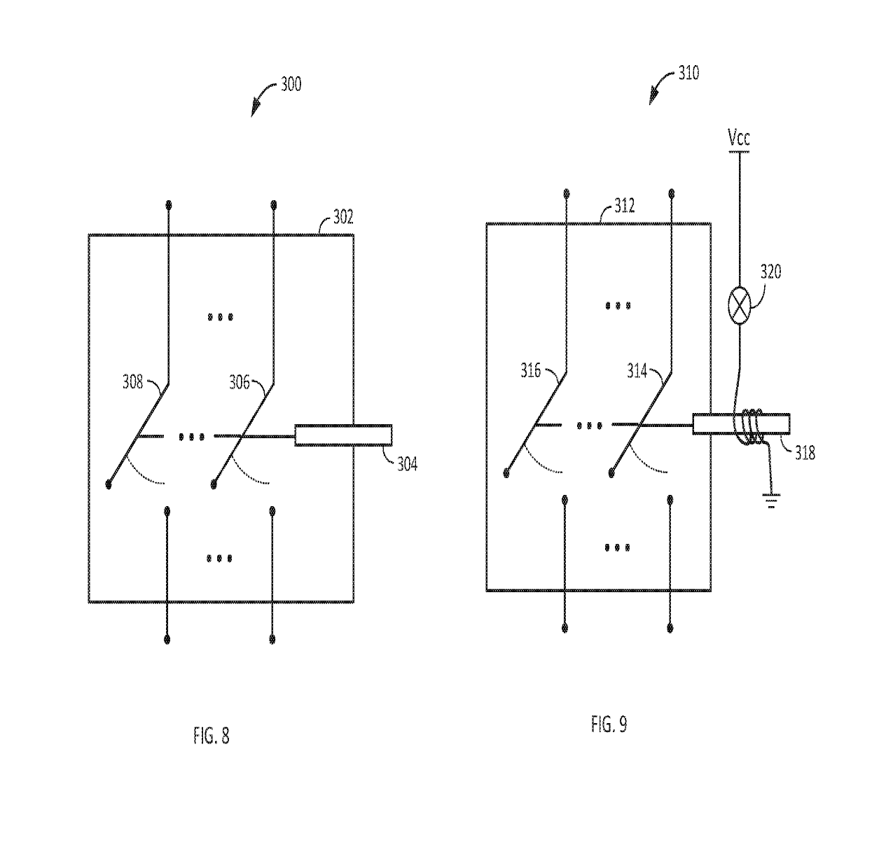

In an embodiment, sets of functions may be grouped together using, for example, a gang switch 300. For example, as depicted in FIG. 8, individual switch armatures 306 and 308 may be mechanically linked so that each armature 306, 308 is connected or disconnected by a single operation of the lever 304. As depicted, more than two armatures may be linked in this fashion. In this way, components/services such as cellular service, Bluetooth, and WiFi may be grouped for unitary operation. Similarly, a group such as GPS, microphone and camera may be implemented.

In an alternative embodiment illustrated in FIG. 9, a gang switch 310 may be electrically operated, that is the armatures 314, 316, etc., may be driven with a solenoid 318 with the control of the solenoid 318 through a single manually operated airgap switch 320. In this way, functional groupings may also be developed using only a single switch 320 as a control.

FIG. 10 illustrates another embodiment of using airgap switches 150 to implement an additional level of security in the communication device 100. In this embodiment, multiple individual switches may be connected so that pattern of switches must be activated for a feature to be enabled or disabled. As shown, switches 320 and 322 are connected in series and switches 324 and 328 are connected in series. In this illustration a component whose activation (or deactivation) is associated with terminal 330 may be only be accomplished if both switches 320 and 322 are both closed, while if either is open the component is deactivated (or activated). Switch 326 may be left as a dummy or may be coupled to another component in a single switch configuration. In different embodiments, the number of switches available and the number of switches used for controlling a single component may be varied. This simple obfuscation may be useful in deterring or delaying an unauthorized person who is trying to disable or re-enable a particular component or service. In some cases, the various switch activations may be monitored to determine if such an operator is randomly trying combinations and may set an alarm or activate a further disabling technique if too many improper combinations are set.

In another embodiment of combination switches or a mechanical interlock (not depicted) may be used so that an armature 256 is only movable when multiple buttons are pressed at the same time, in a sequence, or a combination of both.

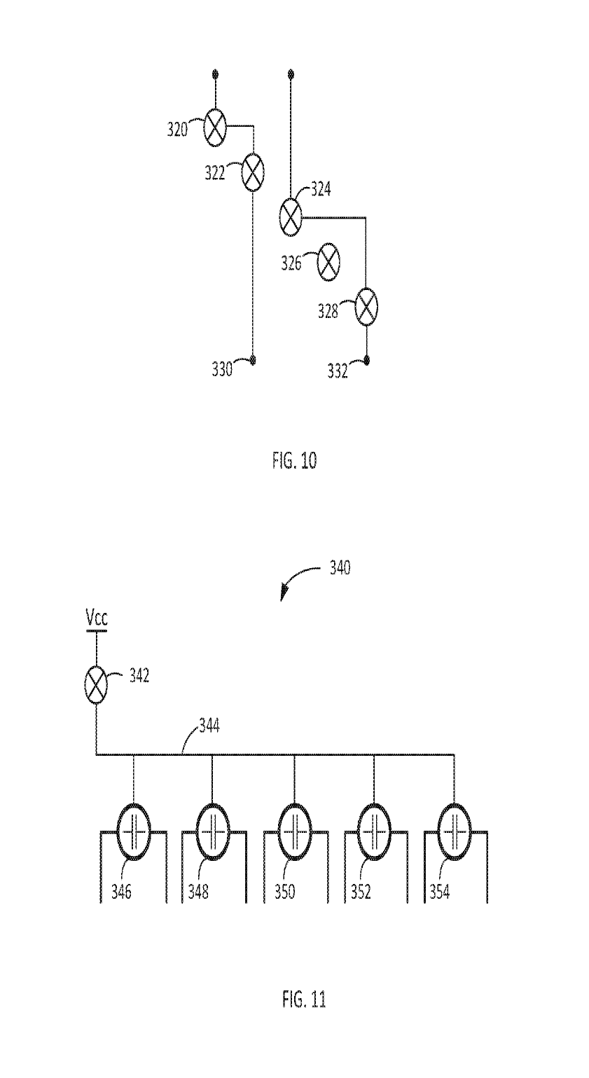

FIG. 11 illustrates another switch configuration that may be used to positively enable and disable components of the communication device 100. A switch component 340 may include an override or failsafe switch 342 that controls the operation of additional switches 346, 348, 350, 352, 354. Each additional switch, e.g., switch 346 may be an airgap switch or a capacitive switch that connects or disconnects a power or signal line as discussed above. In an embodiment, the switch 346 may control a solenoid 318 or similar mechanism. In this embodiment, the airgap switch 342 controls the power 344 to the additional switches 346-354. In this way, the individual switches 346-354 are prevented from accidental activation by the use of the failsafe switch 342. In different embodiments, the configuration of the failsafe switch 342 may allow specific activation of a component or may allow specific deactivation of the respective functions associated with the switches 346-354. In an embodiment, the switch component 340 may be constructed as a separate assembly and added with minimal redesign of the base circuitry of the communication device 100.

Returning to FIG. 5, another vulnerability for tracking and location discovery may be through the various sensors installed on a well-known communication device 100, such as an accelerometer. FIG. 5 illustrates another configuration that may be used separately or in combination with the airgap switch protections outlined in FIGS. 2, 3, and 4. FIG. 5 shows that the sensor block 118 may include representative sensors such as a barometer 202, a proximity sensor 206, a fingerprint reader 210, an accelerometer 214, and a gyroscope 222.

The sensors may be connected to a sensor interface 228 which itself may provider individual sensor data to the processor 102 via a data connection. Each of sensors is depicted having a separate airgap switch for individual control of the respective sensor's output. In this illustration the barometer 202 may have a switch 204 and the proximity sensor 206 may have switch 208. In an embodiment, the fingerprint reader, which is unlikely to be used in compromising a location or be used for eavesdropping may have an airgap switch 212 or may not.

The accelerometer 214 may have an airgap switch 216 and the compass may have an airgap switch 220. Each of the airgap switches may control flow of data from its respective sensor to the sensor interface 228. As discussed above, another way to disable a device is remove its power. The gyroscope 222 is illustrated as having both a data airgap switch 224 and a power airgap switch 226. In different embodiments, each of the sensors may have one, the other, or both airgap switches to control the operation of that sensor.

In another embodiment, the sensor interface may have an airgap switch 230 that interrupts the signal from the sensor interface 228 to the processor 102. The airgap switch 230 may interrupt the signal line or may cause a bus driver to power off or go to a non-transmit mode, such as a tri-state or high impedance mode. In such a mode, the sensor interface neither reads or writes to the data bus to the processor 102.

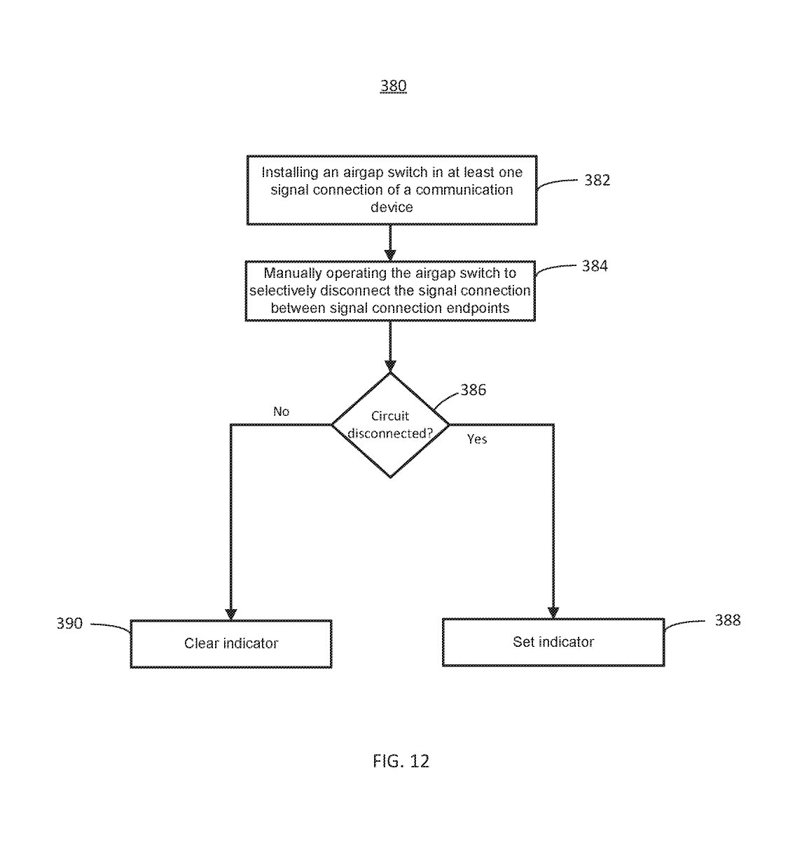

FIG. 12 is a flowchart of a method 380 of operating an communication device in accordance with the current disclosure. At block 382, an airgap switch 150 may be installed in at least one signal connection of a communication device 100. For example, the airgap switch 150 may be connected to one or more of a signaling device 124, 126, 128, 130, or related antenna switch 134. In another embodiment, the airgap switch 150 may be coupled to one or more of a plurality of transducers such as transducers 108, 110, 112, and 116. In yet another embodiment, the airgap switch 150 may be coupled to one or more of a plurality of sensors such as sensors 202, 206, 210, 214 and 222. In various embodiments, airgap switches 150 may be coupled to various combinations of the signaling devices, transducers, and sensors.

At block 384, one or more of the airgap switches may be manually operated to selectively disconnect or disable its associated component. In one embodiment, the airgap switch may interrupt a signal line carrying data from the component to the processor or to a respective antenna. In another embodiment, the airgap switch may disconnect power to the component in order to inhibit its operation.

At block 386 a determination may be made if the circuit associated with the component is disabled, as discussed above. If so, the yes' branch may be taken to block 388 and an indicator, such as the light 264 may be activated. If at block 386 the component is not disabled, the ‘no’ branch may be taken to block 390 and the light 264 may be deactivated. In other embodiments, it may be desirable to have the light 264 activated when the component is deactivated, indicate a “safe” operating mode. While the light 264 may be activated and deactivated by a double pole single throw switch as discussed above, other alternatives may be used. For example, when a component is controlled by switching power to the component, the light may be connected to the component side of the airgap switch 150 so that when the component has power the light is on.

A technical effect of the airgap switch 150 is to manually enable and disable a component of the communication device 100 even if a rogue application or compromised system software attempts to operate the component in a surreptitious manner.

The ability to positively shut off certain elements of a personal communication device benefits users by ensuring that features and functions of the device are not used without the device owner's knowledge either inadvertently or as the result of the device being compromised.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A communication device comprising:
a processor that executes stored instructions;
a memory coupled to the processor, the memory storing executable instructions and data;
a plurality of signaling devices, each of the plurality of signaling devices individually coupled to the processor; and
an airgap switch coupled to one of the plurality of signaling devices, the airgap switch manually operable to selectively enable operation of the one of the plurality of signaling devices.

2. The communication device of claim 1, wherein the respective one of the plurality of signaling devices is a wireless cellular network transceiver and the airgap switch manually operates an antenna relay to a receive-only position.

3. The communication device of claim 1, wherein the respective one of the plurality of signaling devices is a near field communication (NFC) transceiver and the airgap switch enables the NFC transceiver only when manually activated during an entire communication session between the NFC transceiver and a terminal device.

4. The communication device of claim 3, wherein an electrical circuit that supplies power to the NFC transceiver includes the airgap switch in a normally open configuration to enable operation of the NFC transceiver only when manually activated.

5. The communication device of claim 3, wherein the airgap switch is coupled between the NFC transceiver and a respective antenna, the airgap switch in a normally open position disconnecting a signal output of the NFC transceiver from the antenna.

6. The communication device of claim 1, further comprising:
a GPS receiver;
a GPS antenna coupled to the GPS receiver; and
a second airgap switch coupled between the GPS receiver and the GPS antenna.

7. The communication device of claim 1, further comprising a light coupled to the airgap switch, the light indicating an operational state of the respective one of the plurality of signaling devices.

8. The communication device of claim 1, further comprising:
a plurality of transducers coupled to the processor; and
a transducer airgap switch coupled to a respective one of the plurality of transducers, the transducer airgap switch manually operable to selectively enable operation of the respective one of the plurality of transducers.

9. The communication device of claim 8, wherein the one of the plurality of transducers is a camera and the transducer airgap switch selectively disconnects power to the camera.

10. The communication device of claim 8, wherein the one of the plurality of transducers is a microphone and the transducer airgap switch selectively interrupts an electrical signal from the microphone to the processor.

11. The communication device of claim 8, further comprising a plurality of sensors; and
a sensor airgap switch coupled to a respective one of the plurality of sensors, the sensor airgap switch manually operable to selectively enable operation of the respective one of the plurality of sensors.

12. The communication device of claim 11, wherein the respective one of the plurality of sensors is an accelerometer and the sensor airgap switch disconnects an output of the accelerometer from the processor.

13. A method of operating a communication device having a processor and memory, a cellular transceiver, a GPS receiver, and a camera, the method comprising:
coupling the processor to the cellular transceiver, the GPS receiver, and the camera, each of the couplings via a respective single signal connection;
installing a first airgap switch in one of the signal connections; and
manually operating the first airgap switch to disconnect the signal connection between the processor and the corresponding one of the cellular transceiver, the GPS receiver, or the camera.

14. The method of claim 13, wherein installing the first airgap switch in one of the signal connections comprises installing the first airgap switch in the signal connection between the GPS receiver and the processor.

15. The method of claim 13, wherein installing the first airgap switch in one of the signal connections comprises installing the first airgap switch in the signal connection between the camera and the processor.

16. The method of claim 13, wherein installing the first airgap switch in one of the signal connections comprises installing the first airgap switch in one of an electric circuit or an optical circuit.

17. A communication device comprising:
a processor that executes stored instructions;
a memory coupled to the processor, the memory storing executable instructions and data;
a plurality of signaling devices, each of the plurality of signaling devices individually coupled to the processor;
an airgap switch coupled to one of the plurality of signaling devices, the airgap switch manually operable to selectively enable operation of the one of the plurality of signaling devices;
a plurality of transducers coupled to the processor;
a transducer airgap switch coupled to a respective one of the plurality of transducers, the transducer airgap switch manually operable to selectively enable operation of the respective one of the plurality of transducers;
a plurality of sensors; and
a sensor airgap switch coupled to a respective one of the plurality of sensors, the sensor airgap switch manually operable to selectively enable operation of the respective one of the plurality of sensors.

18. The communication device of claim 17, wherein the respective one of the plurality of signaling devices is a WiFi transceiver and the airgap switch manually disconnects a WiFi antenna from the WiFi transceiver.

19. The communication device of claim 17, further comprising an optical coupler connecting the processor to a speaker.

20. The communication device of claim 17, further comprising a subscriber identity module (SIM) reader and a SIM reader airgap switch that disconnects the SIM reader from the processor.
